(19) United States
(12) Patent Application Publication
(10) Pub. No.: US 2025/0376141 A1
(43) Pub. Date: Dec. 11, 2025

(54) APPARATUS FOR DRUM BRAKE ASSEMBLY

(71) Applicants: ZF Active Safety US Inc., Livonia, MI (US); ZF Friedrichshafen AG, Friedrichshafen (DE); ZF Active Safety GmbH, Koblenz (DE); ZF Automotive Brasil Ltda., Limeira (BR)

(72) Inventors: Thomas Schwegler, Tettnang (DE); Detlef Baasch, Oberteuringen (DE); Andreas Knoll, Lindau (DE); Marc Schieß, Hohenfels (DE); Martin Ruider, Schwarzhofen (DE); Ingo Decker, Friedrichshafen (DE); Galus Chelaidite, South Lyon, MI (US); Lukas Madzgalla, Lahnstein (DE); Rui Bertim de Campos, Limeira (BR); Michael Pantke, Friedrichshafen (DE); Nico Rueß, Meckenbeuren (DE); Tobias Stanger, Attenweiler (DE); Michael Huber, Langenargen (DE)

(21) Appl. No.: 18/739,711

(22) Filed: Jun. 11, 2024

(51) Int. Cl. B60T 13/74; F16D 51/22; F16D 65/22; F16D 65/56; F16D 121/20; F16D 121/24; F16D 125/36; F16D 125/40; F16D 125/50; F16D 127/02

(52) U.S. Cl. CPC B60T 13/746; F16D 65/22; F16D 65/562; F16D 51/22; F16D 2121/20; F16D 2121/24; F16D 2125/36; F16D 2125/40; F16D 2125/50; F16D 2127/02

(57) ABSTRACT

An apparatus for a drum brake assembly having first and second brake shoes includes a motor and a gear train for receiving torque from the motor and having a pinion gear. First and second ball ramp assemblies receive torque from the pinion gear and have ends aligned with the respective first and second brake shoes. The motor is actuatable for lengthening each ball ramp assembly to move the brake shoes and apply braking force to the brake drum.

### TECHNICAL FIELD

The present invention relates generally to braking systems, and specifically to a brake pad actuator for a drum brake assembly.

### BACKGROUND

Drum brakes are typically provided on the rear wheels of vehicles in order to brake the vehicle wheels. The brakes include brake shoes selectively movable away from one another and forced into engagement with the brake drum and prevented from rotating with the brake drum to apply braking force to the brake drum via the friction material bonded to each brake shoe. The brake shoes are maintained in this position to apply and hold the brake until released by the vehicle operator.

### SUMMARY

In one aspect of the invention, an apparatus for a drum brake assembly having first and second brake shoes includes a motor and a planetary gear train for receiving torque from the motor and having a pinion gear. First and second ball ramp assemblies receive torque from the pinion gear and have ends aligned with the respective first and second brake shoes. The motor is actuatable for lengthening each ball ramp assembly to move the brake shoes and apply braking force to the brake drum.

In another aspect, an apparatus for a drum brake assembly having first and second brake shoes includes a motor with a pinion gear and a planetary gear train for receiving torque from the motor pinion gear and having two output gears. First and second ball ramp assemblies receive torque from the planetary gear train output gears and have ends aligned with the respective first and second brake shoes. Each ball ramp assembly contains a nut which includes a first ramp unthreaded with the spindle for receiving torque from the planetary gear train output gear, a second ramp threaded to the spindle and movable therewith, a biasing member, a circlip, and thrust bearing for preloading the first and second ramps, and rolling members provided between the first and second ramps. The motor is actuatable to rotate the first ramp of each ball ramp assembly in a direction to cause the rolling members to transmit torque into the second ball ramp such that it rotates onto the spindle to force the spindle to move the brake shoes toward the brake drum. The motor is actuatable in the same direction to rotate the first ramp with the second ramp to advance the spindle relative to the nut to account for wear on the brake shoes. A brake system having a first function to allow torque transfer between the motor and the planetary gear train for applying or releasing braking force on the brake drum and a second function to prevent torque transfer between the motor and the planetary gear train to apply and maintain a parking brake to the brake drum via a solenoid activated park pawl.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a drum brake assembly in accordance with an aspect of the present invention.

FIG. 2 is a schematic illustration of a brake drum of the drum brake assembly.

FIG. 3 is a schematic illustration of an example brake shoe actuation device prior to performing a braking event.

FIG. 4 is an enlarged view of a portion of FIG. 3.

FIG. 5 is a schematic illustration of the actuation device automatically adjusting in response to wear on the brake shoes.

FIG. 6 is a schematic illustration of the actuation device when a service brake operation is performed.

FIG. 7 is a schematic illustration of the actuation device returning to a home position after automatically adjusting.

FIG. 8 is a schematic illustration of another actuation device prior to performing a braking event.

FIG. 9 is a schematic illustration of the actuation device of FIG. 8 when service braking is performed.

FIG. 10 is a schematic illustration of the actuation device of FIG. 8 automatically adjusting in response to wear on the brake shoes.

### DETAILED DESCRIPTION

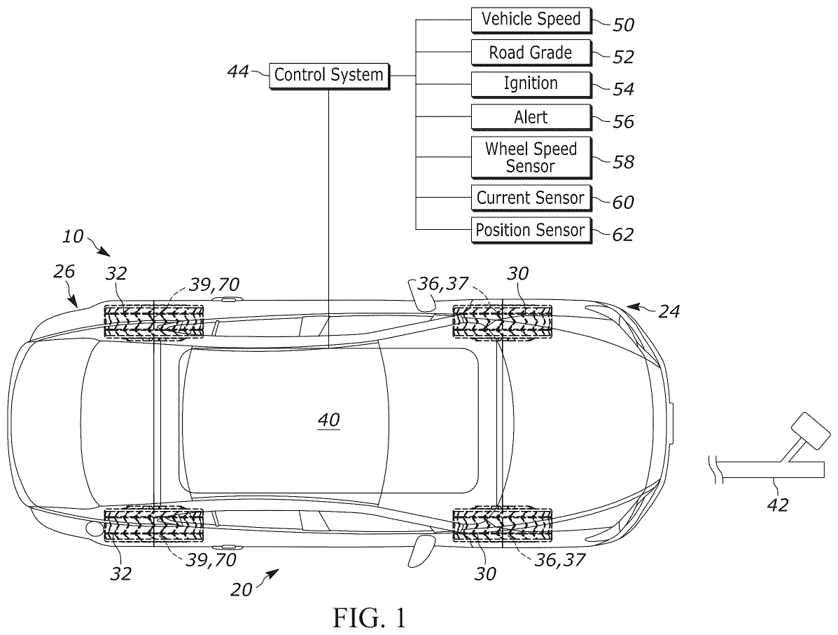

The present invention relates generally to service braking systems, and specifically to a brake shoe actuation device for a drum brake assembly. FIG. 1 illustrates an example electric brake/braking system 10 for a motor vehicle 20 in accordance with the present invention.

The vehicle 20 extends from a first or front end 24 to a second or rear end 26. A pair of steerable wheels 30 is provided at the front end 24. Each wheel 30 includes a wheel drum 36 driven and steered by a steering linkage (not shown). Drum brakes 37 are associated with each wheel drum 36. A brake pedal 42 can be used to actuate the drum brakes 37 to apply service braking to the wheels 30.

A pair of steerable or non-steerable wheels 32 is provided at the rear end 26. As shown, each rear wheel 32 includes a brake drum (not shown) driven by a steering linkage (not shown). Service brake electromechanical drum brake assemblies 39, henceforth referred to as “eDrum”, e.g., drum brake assemblies, are associated with each drum. It will be appreciated that the eDrum 39 could alternatively or additionally by used on the wheels 30 in lieu of the disc brakes 37. A propulsion system 40, e.g., an engine and/or battery, supplies torque to the wheels 30.

A control system 44 is provided to help control operation of the vehicle 20, such as operation of the propulsion system 40 and vehicle braking, including operation of the parking brake function of the eDrum 39. To this end, the control system 44 can include one or more controllers, such as a propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of ignition status. A wheel speed sensor 58 is provided on/adjacent to each wheel 32 and generates signals indicative of the speed at each wheel. The control system 44 also receives signals indicative of the degree—including velocity and acceleration—the brake pedal 42 is depressed.

The control system 44 can receive and interpret these signals and perform vehicle functions, e.g., braking, in response thereto. In one example, the control system 44 can detect wheel slip between one or more wheels 30, 32 and the driving surface based on the sensors 50, 58 and perform anti-lock braking (ABS) and/or electronic stability control (ESC) using one or more disc and/or drum brakes 37. The control system 44 can also be connected to an alert 56 for notifying the driver/operator of the vehicle 20 of vehicle conditions, vehicle status, braking events, and/or environmental conditions.

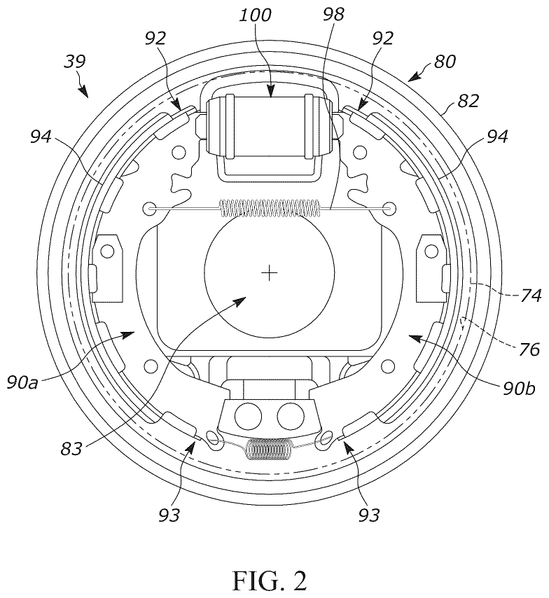

Referring to FIG. 2, the eDrum 39 includes an adapter or backplate assembly 80. The adapter assembly 80 includes a central adapter or backplate 82 having a central opening 83. A pair of brake shoes 90a, 90b is mounted to the back plate 82 on opposite sides of the opening 83 and within the same plane as one another. Each brake shoe 90a, 90b extends from a first end 92 (upper as shown) to a second end 93 (lower as shown). The eDrum 39 is positioned within a brake drum 74 having an inner surface 76 (both illustrated in phantom in FIG. 2) confronting the brake shoes 90a, 90b.

Friction material 94 is secured or bonded to each brake shoes 90a, 90b and has the same shape and general contour as the inner surface 76 of the brake drum 74. A tension spring 98 is connected to each brake shoe 90a, 90b for biasing the brake shoes towards one another.

The brake shoes 90a, 90b are selectively operable between braking and non-braking positions. In the braking position, the brake shoes 90a, 90b contact and press against the inner surface 76 of the brake drum 74 to slow or otherwise stop rotation of [in this example] the rear wheel 32 (FIG. 1) to which the brake drum is rotationally fixed. In the non-braking position, the brake shoes 90a, 90b do not contact the inner surface 76 of the brake drum 74 and thereby allow the rear wheel 32 to rotate freely.

An actuator 100 is secured to the backplate assembly 80 and positioned generally between the ends 92 of the brake shoes 90a, 90b. The actuator 100 is responsible for displacing the ends 92 for selectively applying the service brake and/or parking brake, as will be discussed.

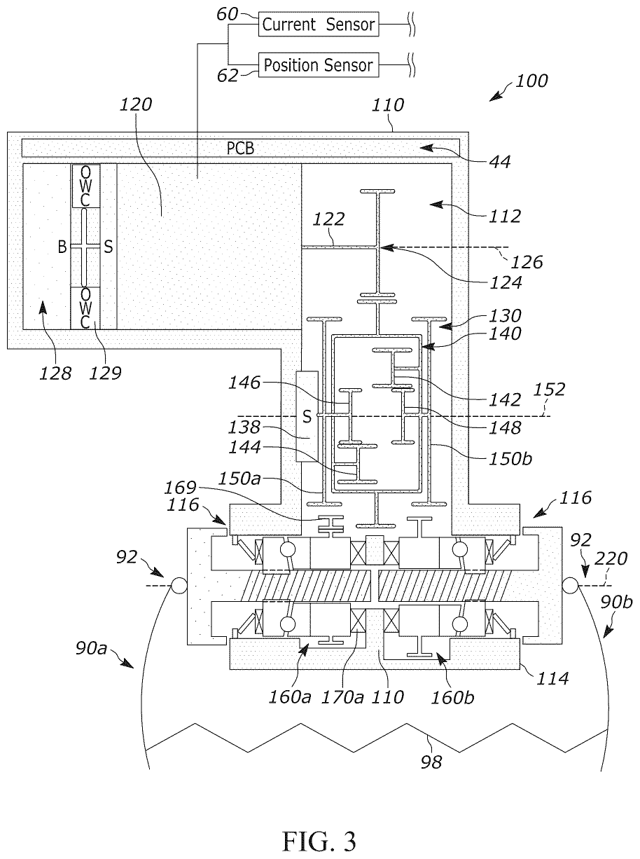

As shown in FIG. 3, the actuator 100 includes a housing 110 defining an interior space 112 and fixed in place in the vehicle 20. A tubular guide 114 is provided at an end of the housing 110. A pair of openings 116 extends through opposite ends of the guide 114 to the interior space 112.

The actuator 100 further includes a motor 120 coupled to a gear train 130, e.g., a planetary or differential gear train. In particular, a shaft 122 extends from the motor 120 and has a pinion gear 124 rotatable therewith about an axis 126. A current sensor 60 and rotational position sensor 62 are connected to the motor 120 and to the control system 44 for sending/receiving signals indicative of the motor operation.

A brake system 128 having a solenoid brake or solenoid clutch 129 is also provided in the housing 110 and coupled to the motor 120 and the control system 44 for selectively braking/preventing rotation of the shaft 122. In one example, the brake solenoid 129 is similar or identical to that shown and described in copending U.S. Application No. XX/XXX, XXX, filed xx/xx/xxxx, the entirety of which is incorporated by reference herein. It will also be appreciated that the control system 44 can be integrated into the actuator 100 (as shown) or formed as part of the larger vehicle control system (not shown).

The planetary gear train 130 is configured to deliver torque from the motor 120 to a pair of ball ramp assemblies 160 provided within the guide 114 and aligned with the ends 92 of the brake shoes 90a, 90b. In one example, the planetary gear train 130 includes a carrier 140 meshed with the pinion gear 124. The carrier 140 is also connected to and rotatable with planet gears 142, 144 that are respectively meshed with sun gears 146, 148. The sun gears 146, 148, in turn, rotate with respective output gears 150a, 150b about a common axis 152. A torque sensor 138 can be provided on the planetary gear train 130 for monitoring the torque delivered to the planetary gear train from the motor 120.

The output gears 150a, 150b are each meshed with a respective ball ramp assembly 160a, 160b provided within the guide 114 of the housing 110 and aligned with one another along a common centerline 220. An example ball ramp assembly is shown and described in U.S. patent application Ser. No. 16/157,027, filed Oct. 10, 2018, the entirety of which is incorporated herein by reference. In this particular example, the ball ramp assemblies 160 are substantially identical and therefore given the suffixes “a” and “b” for clarity. The ball ramp assemblies 160a, 160b are aligned with one another and extend through the opposing openings 116 in the guide 114. That said, only the description of the ball ramp assembly 160a is provided for brevity.

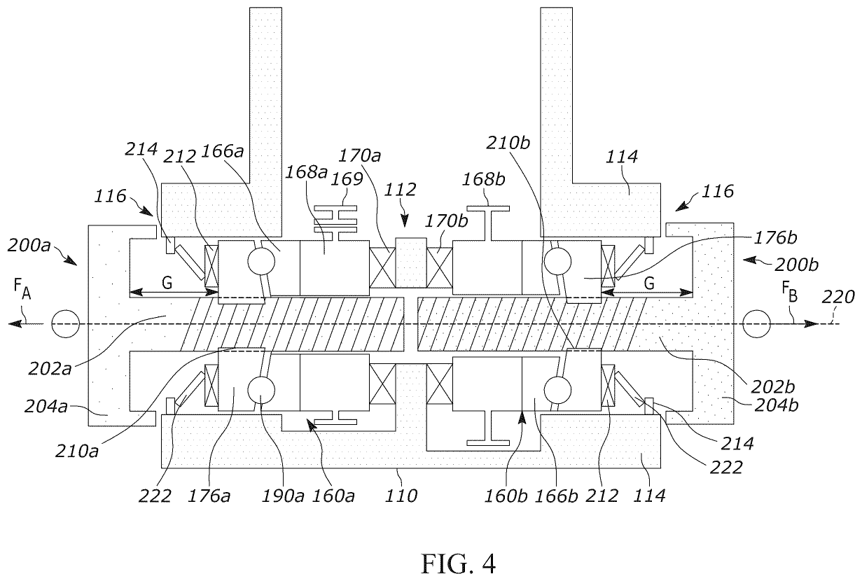

Referring to FIG. 4, the ball ramp assembly 160a includes a nut 162a formed from two separate components, namely, a first ramp 166a and a second ramp 176a longitudinally aligned with one another. Rolling members 190 are provided between the first and second ramps 166a, 176a. The rolling members 190a can be, for example, ball bearings.

The first ramp 166a includes or is integrally formed with a gear 168a. An idler gear 169 is in meshed engagement with both the gear 168a and the output gear 150a of the planetary gear train 130. The first ramp 166b includes or is integrally formed with a gear 168b for meshed engagement with the output gear 150b of the planetary gear train 130. Consequently, the output gear 150a is responsible for delivering torque to the ball ramp assembly 160a and the output gear 150b is responsible for delivering torque to the ball ramp assembly 160b. That said, a thrust bearing 170 is provided between and aligned with the gears 168a, 168b for enabling axial force transfer therebetween.

It will be appreciated that the output gears 150a, 150b rotate in the same direction and, thus, the idler gear 169 is provided such that the gears 168a, 168b rotate in opposite directions. This allows two of the same ball ramp assemblies 160a, 160b to be used in the actuator 100. With this in mind, the diameters of the gears 150a, 150b, 168a, 168b, 169 will be designed to ensure the gear ratios from the planetary gear train 130 to the ball ramp assemblies 160a, 160b is equal.

A thrust bearing 212 abuts the second ramp 176a and is biased into engagement therewith by a biasing member 222. The biasing member 222 can be, for example, a compression spring or elastomeric member, one or more Belleville washers or the like. The biasing member 222, in turn, is retained by a clip or circlip 214 positioned within a groove in guide 114. A main thrust bearing 170a, 170b is provided between each ball ramp assembly 160a, 160b and the housing 110. It will be appreciated that alternatively a single main thrust bearing (not shown) can replace the pair of thrust bearings shown, in which case appropriate mounting accommodations and housing modifications are made. That said, the load applied by the biasing member 222 is supported by the main thrust bearing 170a which itself is finally supported by the housing 110.

The ball ramp assembly 160a further includes a spindle 200a having a shaft 202a extending though the second ramp 176a and into the first ramp 166a. More specifically, the shaft 202a has a threaded connection 210a with the second ramp 176a and passes freely into the first ramp 166a. A head 204a extends radially from the shaft 202a and is positioned within one of the openings 116 in the guide 114. A longitudinal gap G is defined between the surfaces of the second ramp 176a and head 204a facing/opposing one another. The thrust bearing 312, biasing member 316, and circlip 320 cooperate to preload the components 162a, 200a.

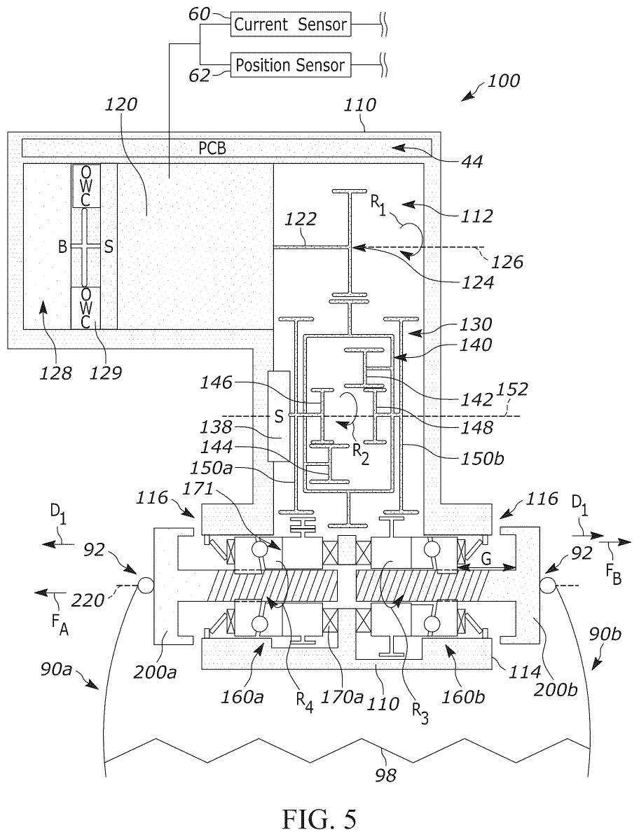

Operation of the brakes is illustrated in FIGS. 5-7. During operation of the vehicle 20, the driver depresses the brake pedal 42 (see also FIG. 1) to operate the disc brake assemblies 39 and apply electromechanical service braking to one or more wheels 30, 32. This will decelerate a moving vehicle, bringing it to a stop such that the vehicle 20 remains stationary on a hill (uphill or downhill). In any case, while the brake pedal 42 remains depressed and the vehicle is stationary, the driver can then apply the parking brake, e.g., electronically, by pushing a button, in which case the brake system 128 actuates the solenoid brake 129 to prevent rotation of the shaft 122. Once the solenoid brake 129 locks the shaft 122, electrical power to the motor 120 and to the brake system 128 can be turned off, since the vehicle is successfully parked.

The control system 44 receives signals from one or more of the sensors, e.g., the brake pedal sensor, vehicle speed sensor 50, road grade sensor 52 and/or wheel speed sensor 58, and determines the level of appropriate service braking and whether the parking brake also needs to be applied. Regardless, the control system 44 first actuates the actuator 100 associated with each rear wheel 32.

To this end, and referring to FIG. 5, the control system 44 actuates the motor 120 to rotate the pinion gear 124 about the axis 126 in the manner R₁ (clockwise as shown). This rotates the sun gears 146, 148 about the axis 152 in the manner R₂, which thereby rotates the pair of output gears 150a, 150b in the manner R₂ (also clockwise as shown). Rotation of the output gears 150a, 150b drives rotation of the respective gears 168a, 168b on the ball ramp assemblies 160a, 160b. More specifically, the first ramp 166b is rotated in the manner R₃ and the first ramp 166a is rotated in the opposite manner R₄ on account of the idler gear 169. There is no connection between the ball ramp assemblies 160a, 160b and, thus, they rotate independent of one another. It will be appreciated that the connections between the planetary gear train 130 and the ball ramp assemblies 160a, 160b allows the torque from the motor 120 to be split evenly or substantially evenly between the ball ramp assemblies.

It will be appreciated that a target clearance between the brake shoes 90a, 90b and the drum inner surface 76 before braking commences is desired to ensure consistent braking. It will also be appreciated that the friction material(s) 94 can become worn over time. When this occurs, the target clearance between the brake shoes 90a, 90b and drum inner surface 76 must be maintained.

That said, the ball ramp assemblies 160a, 160b operate in cooperation with the spindles 200a, 200b via the threaded interfaces 210a, 210b therebetween to automatically maintain the target clearance over time as the brake shoes 90a, 90b wear. In particular, the spindles 200a, 200b are configured to automatically increase the gap G at the onset of each braking event by moving in direction D₁ until the target clearance between the brake shoes 90a, 90b and the inner surface 76 of the brake drum 70 is achieved.

As noted, the nuts 162a, 162b are preloaded by the biasing members 222. Furthermore, the threaded connections 210a, 210b between the spindles 200a, 200b and the respective second ramps 176a, 176b is lower efficiency than the high efficiency nuts 162a, 162b. Consequently, when the gears 168a, 168b begin rotating in the manners R₃, R₄, the ball ramp assemblies 160a, 160b rotate as single units without the ramps 166a, 176a and 166b, 176b opening up. At the same time, the spindles 200a, 200b advance outward in the direction D₁ through the threaded interfaces 210a, 210b away from one another and into engagement with the brake shoes 90a, 90b.

The brake shoes 90a, 90b are initially spaced from the inner surface 76 of the brake drum 74, and, thus, there is little to no initial resistance to outward movement of the brake shoes towards the inner surface 76. Consequently, the brake shoes 90a, 90b pivot outward until the friction pads 94 engage the inner surface 76 of the brake drum 74 to apply braking forces F_{A}, F_{B} thereto. This, in turn, imparts a reaction force upon the spindles 200a, 200b, thereby preventing further movement of the spindles along the centerline 220.

The reaction forces on the spindles 200a, 200b increases until a predetermined load is reached at which point the threaded interfaces 210a, 210b become locked to their respective nuts 176a, 176b. In other words, the spindles 200a, 200b are prevented from further advancing relative to the second ramps 176a, 176b. At this point, further rotation of the gears 168a, 168b in the manners R₃, R₄ causes the ball ramp assemblies 160a, 160b to open up to apply high loads necessary to decelerate the vehicle to the brake shoes 90a, 90b.

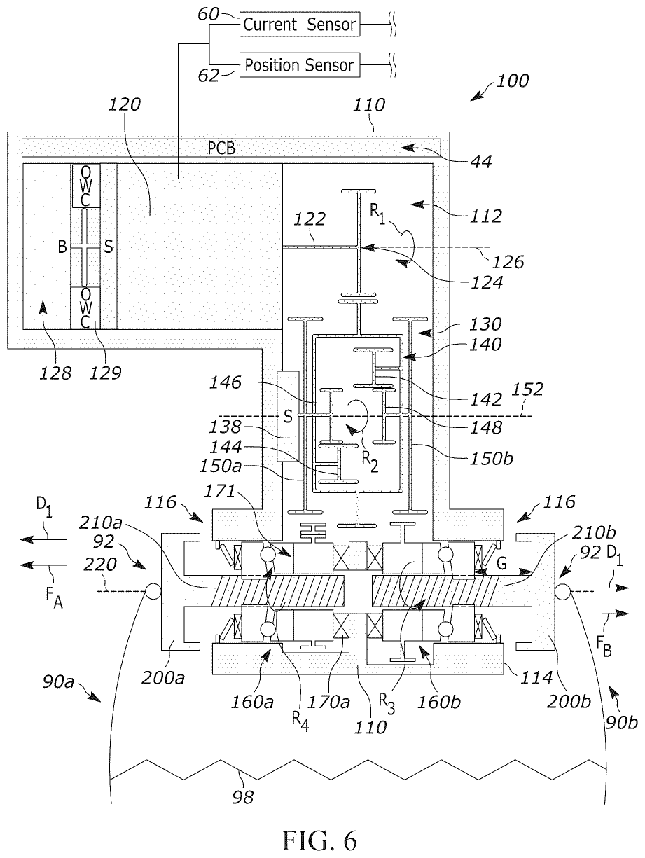

More specifically, as shown in FIG. 6, the rolling members 190a, 190b move up the respective ramps 166a, 176a and 166b, 176b and push the second ramps 176a, 176b [with the spindles 200a, 200b locked thereto] away from the first ramps 166a, 166b in the direction D₁ to apply high loads to the brake shoes 90a, 90b and thereby increase the braking forces F_{A}, F_{B}.

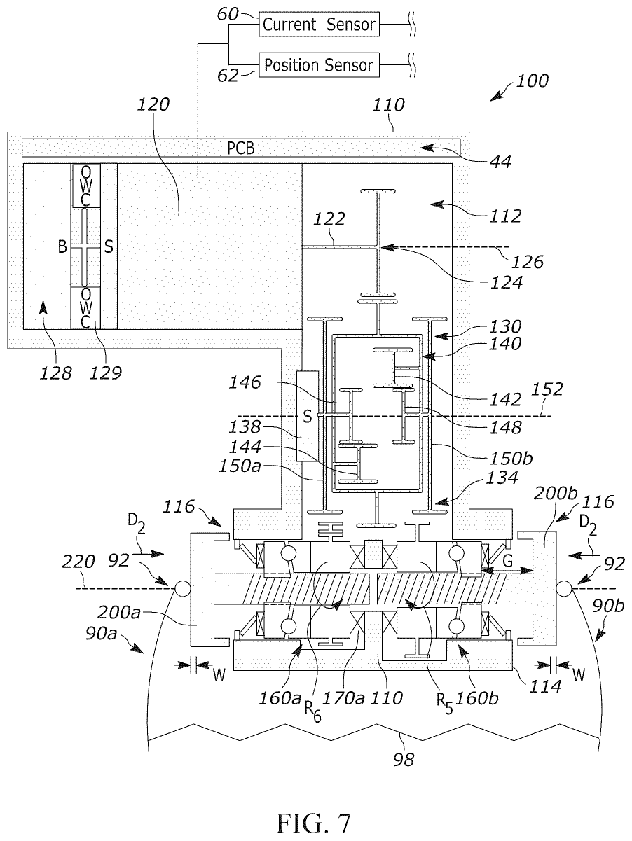

The braking forces F_{A}, F_{B} are maintained on the brake drum 74 until the service braking event ends, such as when the force applied on the brake pedal 42 is released. Note that due to the planetary or differential gear train 130, forces F_{A}, F_{B} are essentially equal to each other at all times as clamp force is increased or decreased. The force reduction on brake pedal 42 is recognized by the control system 44, which commands the motor 120 to rotate in the opposite direction such that the force applied to brake shoes 90a, 90b is reduced. In particular, and referring to FIG. 7, to reduce force on brake shoes 90a, 90b the motor 120 rotates the pinion gear 124 in a direction opposite to the direction R₁. This causes the ball ramp assemblies 160a, 160b to come down, thereby drawing the spindles 200a, 200b towards one another and shortening the overall distance therebetween.

Consequently, the distance between the ends of the brake shoes 90a, 90b is shortened. The tension spring 98 ensures that the brake shoes 90a, 90b are in continuous contact with spindles (or clevises) 200a and 200b and thus with the ball ramp assemblies 160a, 160b as they retract according to the control signal received by the motor 120 from the control system 44. When the forces F_{A}, F_{B} on the brake drum 74 are completely released, and the ball ramp assemblies 160a, 160b entirely closed down, the spindles 200a, 200b now reside at a new home position relative to the second ramps 176a, 176b. In other words, the initial advancing of the spindles 200a, 200b relative to the second ramps 176a, 176b prior to applying the braking force F_{A}, F_{B} is maintained, thereby ensuring that the target clearance is maintained. The starting positions of the axial extents of the spindles 200a, 200b, however, has advanced a width “w” relative to the second ramps 176a, 176b compared to wear compensation, thereby increasing the gap G on each end.

It will be appreciated that the associated pairs of thrust bearings 212, 170a and 212, 170b cooperate to allow the ball ramp assemblies 160a, 160b to rotate as needed during pad wear adjustment. Moreover, when applying high load on the brake shoes 90a, 90b, the second ramps 176a, 176b stop rotating while ball ramps 166a and 166b are allowed to rotate to apply the high load necessary to decelerate the vehicle.

When it is desirable to apply the parking brake, the actuator 100 is actuated until the control system 44 estimates that the target braking force is achieved, at which point the motor is held powered but stationary. The control system 44 actuates the brake system 128 to actuate the solenoid brake 129 to prevent rotation of the shaft 122. Once the solenoid brake 129 locks the shaft 122, the control system 44 reduces the torque demand from the motor 120 until the current draw on the motor 120 suddenly drops to zero, confirming that the carrier 140 is locked. This advantageously allows the braking forces F_{A}, F_{B} to be maintained without relying on torque applied by a powered motor. In other words, the braking forces Fa, Fb are maintained with an unpowered motor. Power to the brake system 128 is removed to lock the solenoid brake 129 to the shaft 122.

The brake drum 74, in turn, exerts reaction forces on the brake shoes 90a, 90b. The reaction forces are transferred from the friction pads 94, to the ends 92 of the brake shoes 90a, 90b, to the ball ramp assemblies 160a, 160b and ultimately to the housing 110. Consequently, the locked nuts 162a, 162b and spindles 200a, 200b oppose the reaction forces applied by the brake drum 74 to the brake shoes 90a, 90b. These reaction forces, in turn, generate back-drive torque in the ball ramp assemblies 160a, 160b, and this back-drive torque is transferred to the planetary gear train 130, which is locked by the brake system 128 via the pinion gear 124.

To release the parking brake, the control system 44 commands the motor 120 to rotate in direction R₁ until the motor supports the full torque due to force on brake shoes 90a, 90b. The motor 120 is then held powered and stationary and the control system 44 also directs electrical power to the brake system 128 to disengage the solenoid brake 129 from the shaft 122.

The control system 44 then ceases power supply to the brake system 128 while reducing torque to the motor 120, which will cause the motor 120 to rotate opposite the direction R₁ (counterclockwise as shown) to cause the actuator 100 to retract until the target clearance between the brake shoes 90a, 90b and the drum inner surface 76 is achieved. More specifically, the ramps 166, 176 in each ball ramp assembly 160a, 160b move towards one another as the rolling members 190 come off the ramps. This removes the forces F_{A}, F_{B} on the brake shoes 90a, 90b while allowing the tension spring 98 to maintain contact between the brake shoes 90a, 90b and each ball ramp assembly 160 at all times. After the ramps 166, 176 fully retract (at home position), continued motor 120 rotation in the release direction rotates the ball ramp assemblies 160a, 160b, thereby retracting the spindles 202a, 202b toward each other until the target clearance between the brake shoes 90a and 90b and the brake drum is achieved, at which point the motor is stopped and powered off.

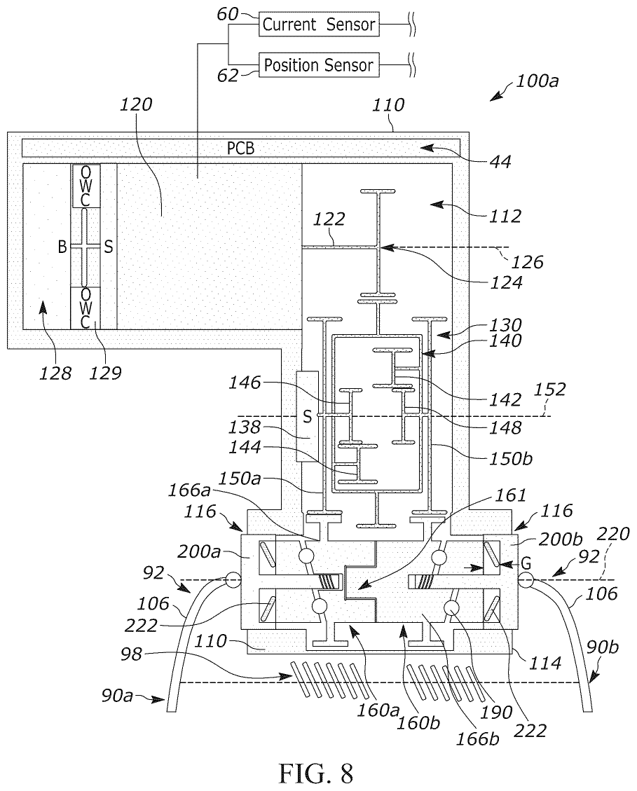

Another actuator 100a having an example ball ramp assembly (or ball ramp and clevis assembly) 160a is illustrated in FIG. 8. Features in FIG. 8 that are similar to those found in FIGS. 1-7 are given the same reference number. In FIG. 8, the ball ramp assemblies 160a, 160b have a cooperating interface 161 that allows for relative rotation therebetween such that the ball ramp assemblies operate independent from one another. Additionally, the gear 169 is omitted in FIGS. 8-10 and, thus, the ball ramp assemblies 160a, 160b are configured, e.g., the threads and ramp orientations of one ball ramp assembly is reversed compared to the other ball ramp assembly, such that the ball ramp assemblies simultaneously rotate in the aforementioned opposite directions R₃, R₄, in response to rotation of the carrier 140. For the planetary or differential gear train 130 to equalize forces Fa, Fb, the first ramps 166a and 166b must be allowed to rotate slightly relative to each other and, thus, a thrust bearing 170 (not shown in this FIGS. 8, 9 and 10) is located between the first ramps 166a and 166b.

Furthermore, the biasing members 222 are provided in the gap G, and the circlips and thrust bearings omitted. As will be discussed, the actuator 100a applies the braking forces F_{A}, F_{B} in fundamentally the same manner as the actuator 100 but the target clearance is maintained in a different manner.

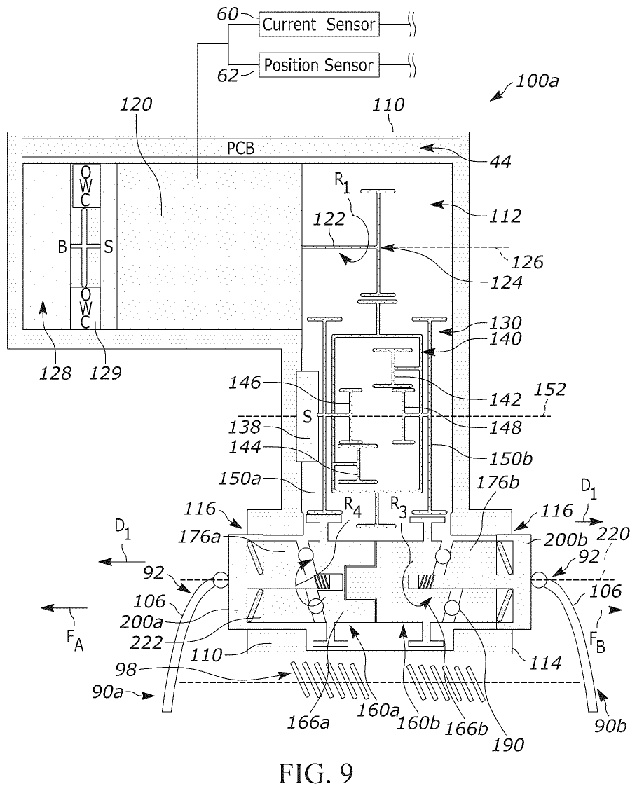

To this end, and referring to FIGS. 8-9, when service braking is requested the control system 44 actuates the motor 120 to rotate the pinion gear 124 about the axis 126 in the manner R₁. This, as described above, rotates the first ramps 166a, 166b in the respective manners R₃, R₄. As a result, the second ramps 176a, 176b and the spindles 200a, 200b connected thereto are driven away from the first ramps 166a, 166b and out of the opening 116 in the direction D₁. Rotation of the pinion gear 124 in the manner R₁ continues until the braking forces F_{A}, F_{B} are applied to the brake drum 74.

The braking forces F_{A}, F_{B} are maintained on the brake drum 74 until the service braking event ends, such as when the force applied on the brake pedal 42 is released. The force reduction on brake pedal 42 is recognized by the control system 44, which commands the motor 120 to rotate in the opposite direction such that the force applied to the brake shoes 90a, 90b is reduced. This causes the gears 168 and, thus, the first ramps 166a, 166b to reverse rotate, thereby causing the spindles 200a, 200b to be retracted into the nuts 162a, 162b as the ramps 166, 176 move towards one another until the target clearance to the drum inner surface 76 is achieved.

More specifically, the control system 44 receives signals from the sensors 60, 62 and monitors the same during braking events. In this manner, the control system 44 can calculate and monitor the forces F_{A}, F_{B} acting on the brake shoes 90a, 90b and make adjustments to the motor 120 torque and length of the ball ramp assemblies 160a, 160b in response thereto. The sensors 60, 62 can also allow the control system 44 to monitor the axial position of the spindles 200a, 200b before, during, and after braking events.

The control system 44 tracks the position of the motor 120 [and therefore the length of the ball ramp assemblies 160a, 160b] such that the target clearance between the brake shoes 90a, 90b and the drum inner surface 76 is known and tracked. When the ball ramp assemblies 160a, 160b achieve the target clearance level, the control system 44 commands the motor 120 to stop and at the same time (or immediately thereafter) commands the brake system 128 to actuate the solenoid brake 129 to prevent rotation of the shaft 122 and maintain the target clearance. Power to the motor 120 is then turned OFF.

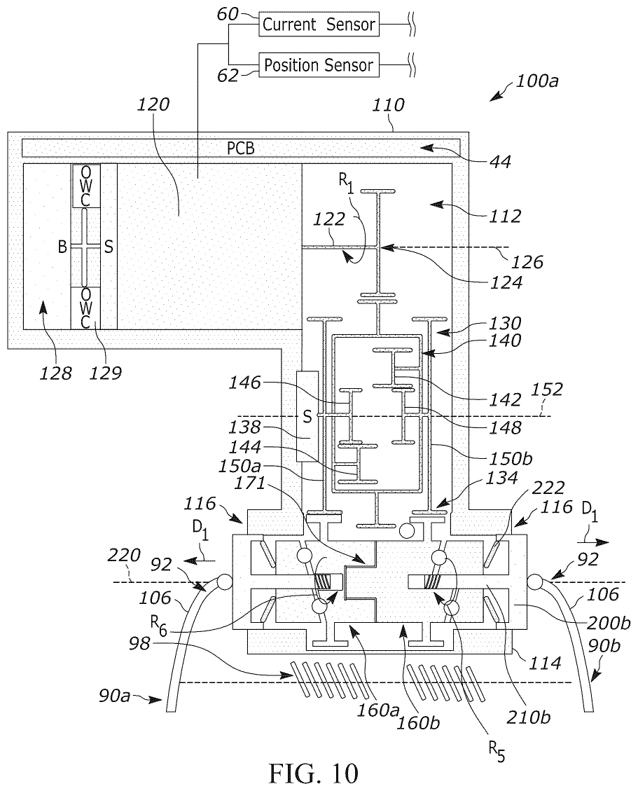

As noted, the friction material(s) 94 can become worn over time and, thus, the target clearance between the brake shoes 90a, 90b and drum inner surface 76 must be maintained. The operation of each ball ramp assembly 160a, 160b is identical so only the specific operation of the ball ramp assembly 160b is discussed for brevity. That said, and turning to FIG. 10, when the control system 44 determines that the entire ball ramp assembly 160b (collectively including the ball nut 162b and the spindle 200b) will run out of stroke, at the earliest safe opportunity, the control system will command the motor 120 to run in an opposite direction to R₁. This, in turn, causes the first ramp 166b to rotate in the direction R₅ and this rotation is continued until the ball ramps 162b is fully retracted to its home positions. For clarity, the same occurs by rotating the first ramp 166a in the direction R₆. Continued rotation of the first ramp 166b in the direction R₅ causes the spindles 200b to move in the direction D₁ relative to the nut 162b to adjust for wear on the brake shoe 90a, 90b.

When the control system 44 tracking the motor 120 position, and thus the spindle 200b position, determines that the target clearance of the brake shoes 90a,90b to the drum surface 74 is achieved, the motor 120 is stopped, ending the brake shoe wear adjustment. Note that while the spindle 200b is moving in direction D₁ and is adjusted for pad wear, the biasing member 222 continues to apply some minimal force between the spindle 200b and the second ramp 176b. This minimal force application ensures the spindle 200b and second ramp 176b remain locked through their thread engagement 210b during normal service brake events of the eDrum 39, i.e., the biasing member 222 has sufficient stroke and force application to prevent relative rotation between the spindle and the ramp during brake events. The biasing member 222 is designed in such a way to perform its function (to preload the components 176b, 200b) whether the brake shoes 90a,90b are new or fully worn.

To this end, the biasing members 222 axially bias the spindle 200b away from the nut 162b. The biasing members 222, however, prevent rotation of the spindle 200b in a manner that translates the spindle 200b away or towards the second ramp 176b outside of wear adjustment events. In other words, the biasing members 222 provides a constant load at the interface 210b between the spindle 200b and the second ramp 176b in a manner that prevents relative rotation therebetween during service brake apply and release events. Consequently, once the spindle 200b is advanced axially relative to the nut 162b (to accommodate wear on the brake shoes 90a, 90b), this becomes the new default/home condition from which subsequent braking events begin—the overall length of the combined second ramp 176b and spindle 200b does not decrease. The above paragraphs describing the operation of the eDrum 39 in FIGS. 8-10 and, in particular, the wear adjustment operation, are also covered in U.S. Pat. No. 11,511,715, the entirety of which is incorporated herein by reference.

When a subsequent service braking operation is triggered after the wear adjustment operation detailed above, the ball ramp assembly 160b position is as shown in FIG. 4, i.e., fully retracted (at home position). Consequently, the ball ramp assembly 160b can extend/lengthen to apply the braking forces F_{A}, F_{B} to the brake drum 74 in a timely manner. It will be appreciated that application and release of the parking brake for the actuator 100a is the same as described above regarding the actuator 100.

The present invention is advantageous in that enables the actuator to apply equal force to both brake shoes without hydraulic fluid pressure. In other words, the torque delivered by the single motor is distributed evenly to two ball ramp assemblies and, thus, the spindles drive the brake shoes with equal [and opposing] forces towards into engagement with the inner surface of the brake drum. The torque delivered to the ball ramp assemblies can be monitored and controlled in real-time while the actuator, namely, the spindles, automatically adjust for pad wear for gradually lengthening the ball ramp assemblies as the pads become worn. Consequently, the actuator provides repeatable, even force application to both brake shoes through the usable lifespan of the friction pads.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for a brake drum having a drum brake assembly with first and second brake shoes, comprising:
a motor having a pinion gear;
a gear train for receiving torque from the pinion gear;
first and second ball ramp assemblies for receiving torque from the pinion gear and having ends aligned with the respective first and second brake shoes; and
the motor being actuatable for lengthening each ball ramp assembly to move the brake shoes and apply braking force to the brake drum.

2. The apparatus recited in claim 1, wherein the gear train comprises one of a planetary and a differential gear train the evenly divides torque from the motor between the first and second ball ramp assemblies.

3. The apparatus recited in claim 1, wherein each ball ramp assembly comprises a nut for receiving torque from the pinion gear and a spindle threaded with the nut, wherein the motor is actuatable for rotating the nuts to translate the spindles and thereby move the brake shoes to apply braking force to or release braking force from the brake drum.

4. The apparatus recited in claim 3, wherein each nut comprises:
a first ramp unthreaded with the spindle and receiving torque from the motor;
a second ramp threaded to the spindle and movable therewith;
a biasing member, a circlip, a first thrust bearing for preloading the first and second ramps and a second thrust bearing for supporting any force occurring on the ball ramp assemblies; and
rolling members provided between the first and second ramps, wherein rotation of the first ramp relative to the second ramp causes the rolling elements to push the second ramp and the spindle together away from the first ramp to apply the braking force, wherein rotation of the first ramp with the second ramp causes the spindle to advance relative to the nut to account for wear on the brake shoes.

5. The apparatus recited in claim 4, wherein the motor rotates in the same direction when the first ramp rotates with the second ramp and when the first and second ramps rotate relative to one another.

6. The apparatus recited in claim 5, wherein the first and second ramps rotate together until a predetermined reaction force is applied to the spindle, and thereafter rotate relative to one another.

7. The apparatus recited in claim 4, further comprising a brake system having a first condition for allowing torque transfer between the motor and the planetary gear train for applying or releasing braking force on the brake drum and a second condition preventing torque transfer between the motor and the planetary gear train to apply a parking brake to the brake drum.

8. The apparatus recited in claim 7, wherein the brake system comprises a solenoid brake for selectively preventing rotation of a shaft of the motor.

9. The apparatus recited in claim 3, wherein each nut comprises:
a first ramp unthreaded with the spindle and receiving torque from the output gear;
a second ramp having a threaded connection with the spindle;
a biasing member for preloading the spindle relative to the second ramp; and
rolling members provided between the first and second ramps, wherein rotation of the first ramp relative to the second ramp causes the rolling elements to push the second ramp and the spindle together away from the first ramp to apply the braking force, wherein rotation of the first ramp with the second ramp causes the spindle to advance relative to the second ramp account for wear on the brake shoes.

10. The apparatus recited in claim 9, wherein the motor rotates in a first direction to rotate the first ramp with the second ramp and rotates in a second direction opposite the first direction to rotate the first and second ramps relative to one another.

11. The apparatus recited in claim 9, further comprising a brake system having a first condition for allowing torque transfer between the motor and the planetary gear train for applying or releasing braking force on the brake drum and a second condition preventing torque transfer between the motor and the planetary gear train to apply a parking brake to the brake drum.

12. The apparatus recited in claim 9, wherein the brake system comprises a clutch for selectively preventing rotation of a shaft of the motor.

13. The apparatus recited in claim 1, further comprising a guide fixed to the vehicle and receiving the ball ramp assemblies.

14. The apparatus recited in claim 1, further comprising a return spring configured to be connected to both brake shoes for biasing the brake shoes towards one another.

15. An apparatus for a brake drum having a drum brake assembly with first and second brake shoes, comprising:
a motor having a pinion gear;
a gear train for receiving torque from the pinion gear and having two output gears;
first and second ball ramp assemblies for receiving torque from the respective output gears and having ends aligned with the respective first and second brake shoes, wherein each nut comprises:
a first ramp unthreaded with the spindle and receiving torque from one of the output gears;
a second ramp threaded to the spindle and movable therewith;
a biasing member, a circlip, a first thrust bearing for preloading the first and second ramps and a second thrust bearing for supporting any force occurring on the ball ramp assemblies ramps, and
rolling members provided between the first and second ramps;
the motor being actuatable to rotate the first ramp in a direction to cause the rolling members to push the second ramp and the spindle together away from the first ramp to apply a braking force to the brake drum, and the motor being actuatable in the same direction to rotate the first ramp with the second ramp to advance the spindle relative to the nut to account for wear on the brake shoes; and
a brake system having a first condition for allowing torque transfer between the motor and the planetary gear train for applying or releasing braking force on the brake drum and a second condition preventing torque transfer between the motor and the planetary gear train to apply a parking brake to the brake drum.

16. The apparatus recited in claim 15, wherein the first and second ramps rotate together until a predetermined reaction force is applied to the spindle, and thereafter rotate relative to one another.

17. The apparatus recited in claim 15, wherein the brake system comprises a solenoid brake for selectively preventing rotation of a shaft of the motor.

18. The apparatus recited in claim 15, further comprising a guide fixed to the vehicle and receiving the ball ramp assemblies.

19. The apparatus recited in claim 15, further comprising a return spring configured to be connected to both brake shoes for biasing the brake shoes towards one another.

20. The apparatus recited in claim 15, wherein the gear train comprises one of a planetary and a differential gear train the evenly divides torque from the motor between the first and second ball ramp assemblies.
